(19) United States
(12) Patent Application Publication
(10) Pub. No.: US 2010/0107424 A1
(43) Pub. Date: May 6, 2010

(54) Blade release mechanisms for utility knives

(76) Inventors: Michael Garcia, Oakland Park, FL (US); Joseph Deguglimo, Coca Raton, FL (US)

Correspondence Address: Dan M. De La Rosa, Suite 24C, 300 East 77th Street, New York, NY, 10075, US

(21) Appl. No.: 12/587,589

(22) Filed: Oct. 9, 2009

Related U.S. Application Data
(60) Provisional application No. 61/195,922, filed on Oct. 14, 2008.

(51) Int. Cl. B26B 5/00

(52) U.S. Cl. 30/337

(57) ABSTRACT

A blade release mechanism for a folding utility knife is provided, and knife comprising: a handle comprising at least two side walls forming an internal space; a blade holding compartment connected to the handle, the blade holding compartment comprising at least two side walls, a first side wall having a cavity for holding a blade, a second side wall having a cavity for holding a blade release device, at least a portion of the blade holding compartment is designed to be situated within the space of the handle during a closed position, the blade holding compartment comprising an aperture leading from the cavity on the first side wall to the cavity on the second side wall; and a blade release device comprising a slidable portion having first and second opposing sides and at least one spring, the device comprises a blade contacting portion situated in the cavity of the second side wall and adapted to fit through the aperture and contact a blade during a locked position, and the first spring is extended to secure the blade contacting portion to the blade during the locked position, and the slidable portion is moved in a direction to contract the first spring to thereby separate the blade contacting portion from the blade to thereby release the blade from the blade holding compartment.

### RELATED APPLICATION

This application is related to U.S. Provisional Application Ser. No. 61/195,922 entitled “Blade Release Mechanisms For Utility Knife” which was filed on Oct. 14, 2008.

### BACKGROUND OF THE INVENTION

1. Field of the Invention

This invention relates to a blade release system for use with a blade holding compartment, the system comprises: a blade holding compartment comprises at least two side walls forming an internal blade cavity for holding a blade, the blade holding compartment comprises a cavity situated on an external surface on one of the side walls of the blade holding compartment, the blade holding compartment comprises an aperture leading from the cavity on the external surface of one of the side walls to the internal blade cavity; and a blade release device comprising a slidable portion having first and second opposing sides and at least one spring, and the device comprises a blade contacting portion situated on the first side of the slidable portion and adapted to fit through the aperture and contact a blade during a locked position, and the spring is extended to secure the blade contacting portion to the blade during the locked position, and the slidable portion is moved in a direction to contract the spring to thereby release the blade contacting portion from the blade to thereby release the blade from the blade holding compartment.

2. Description of the Related Art

There are various patents covering utility knife type devices. These patents do not provide for any easy mechanism for releasing the blade and do not provide a way to effective remove and replace the blade.

The present invention provides for utility knives with a new and improved blade release mechanism. The present invention overcomes numerous problems presented by the prior art.

### SUMMARY OF THE INVENTION

In one embodiment, the present invention provides for a utility knife with a blade release device, the knife comprises: a handle comprising at least two side walls forming an internal space; a blade holding compartment connected to the handle, and the blade holding compartment comprises at least two side walls forming an internal blade cavity for holding a blade, at least a portion of the blade holding compartment designed to be situated within the space of the handle during a closed position, the blade holding compartment comprising a cavity situated on an external surface on one of the side walls of the blade holding compartment, the blade holding compartment comprising an aperture leading from the cavity on the external surface of one of the side walls to the internal blade cavity; and a blade release device comprising a slidable portion having first and second opposing sides and at least one spring, the device also comprises a blade contacting portion situated on the first side of the slidable portion and adapted to fit through the aperture and contact a blade during a locked position, the spring is extended to secure the blade contacting portion to the blade during the locked position, and the slidable portion is moved in a direction to contract the spring to thereby separate the blade contacting portion from the blade to thereby release the blade from the blade holding compartment.

In another embodiment, the device further comprises an actuator situated on the second side of the slidable portion, and the actuator is designed to move the slidable portion to release the blade.

In yet another embodiment, the knife further comprises at least one blade. In still another embodiment, the slidable portion comprises an extended portion. In still yet another embodiment, the device further comprises a second spring, the spring is designed to contact the extended portion of the slidable portion, and the second spring is extended to assist in securing the blade contacting portion to the blade during the locked position, and the slidable portion is moved in one direction to contract the first and second springs to thereby separate the blade contracting portion from the blade and thereby release the blade from the internal cavity of the blade holding compartment.

In a further embodiment, the slidable portion of the device comprises upper and lower portions, and the device further comprises a platform situated on the upper portion of the slidable portion. In yet a further embodiment, the blade contacting portion is connected to the platform. In still a further embodiment, the first spring is situated adjacent to the platform. In still yet a further embodiment, the device further comprises a third spring, and the third spring is situated atop the platform.

In another further embodiment, the blade holding compartment further comprises a cover plate for covering the cavity on the external surface of one of the side walls of the blade holding compartment. In another embodiment, the plate cover comprises at least one aperture, and the device further comprises an actuator situated on the second side of the slidable portion, and the actuator is designed to move the slidable portion to release the blade; and at least a portion of the actuator designed to fit through the aperture of the cover plate allowing user access to the actuator.

In yet another embodiment, the slidable portion is moved in an upward direction to contract the first spring and thereby release the blade from the internal cavity of the blade holding compartment. In still another embodiment, the blade holding compartment is pivotally connected to the handle.

In still yet another embodiment, the blade holding compartment comprises at least one channel and the handles comprises at least one protrusion adapted to slide within the channel to thereby allow the blade holding compartment to be slid within the internal space of the handle during the closed position and to be slid away from the internal space of the handle during an opened position.

In a further embodiment, the blade holding compartment comprises at least one protrusion and the handles comprises at least one channel adapted to slide within the channel to thereby allow the blade holding compartment to be slid within the internal space of the handle during the closed position and to be slid away from the internal space of the handle during an opened position.

In another embodiment, the present invention provides for a blade release system for use with a blade holding compartment, the system comprises: a blade holding compartment comprises at least two side walls forming an internal blade cavity for holding a blade, the blade holding compartment comprises a cavity situated on an external surface on one of the side walls of the blade holding compartment, the blade holding compartment comprises an aperture leading from the cavity on the external surface of one of the side walls to the internal blade cavity; and a blade release device comprising a slidable portion having first and second opposing sides and at least one spring, and the device comprises a blade contacting portion situated on the first side of the slidable portion and adapted to fit through the aperture and contact a blade during a locked position, and the spring is extended to secure the blade contacting portion to the blade during the locked position, and the slidable portion is moved in a direction to contract the spring to thereby separate the blade contacting portion from the blade to thereby release the blade from the blade holding compartment.

In yet another embodiment, the system further comprises at least one blade. In still another embodiment, the blade comprises at least one indentation. In still yet another embodiment, the blade contacting portion comprises at least one protrusion, the protrusion contacts the indentation of the blade during the locked position and the protrusion disengages the indentation of the blade to thereby release the blade from the internal cavity of the blade holding compartment.

In a further embodiment, the present invention relates to a knife with blade release system comprising: a handle comprising at least two side walls forming an internal space; a blade holding compartment comprising at least two side walls forming an internal blade cavity for holding a blade, the blade holding compartment comprising a cavity situated on an external surface on one of the side walls of the blade holding compartment, the blade holding compartment comprising an aperture leading from the cavity on the external surface of one of the side walls to the internal blade cavity, the blade holding compartment is situated within the internal space of the handle during a closed position, the blade holding compartment is situated outside the internal space of the handle during an opened position; a blade; and a blade release device comprising a slidable portion having first and second opposing sides and at least one spring, the device comprises a blade contacting portion situated on the first side of the slidable portion and adapted to fit through the aperture and contact a blade during a locked position, the first spring is extended to secure the blade contacting portion to the blade during the locked position, and the slidable portion is moved in a direction to contract the first spring to thereby separate the blade contacting portion from the blade to thereby release the blade from the blade holding compartment.

In another embodiment, the present invention relates to a knife comprising: a handle comprising at least two side walls forming an internal space; a blade holding compartment connected to the handle, the blade holding compartment comprising at least two side walls, a first side wall having a cavity for holding a blade, a second side wall having a cavity for holding a blade release device, at least a portion of the blade holding compartment is designed to be situated within the space of the handle during a closed position, the blade holding compartment comprising an aperture leading from the cavity on the first side wall to the cavity on the second side wall; and a blade release device comprising a slidable portion having first and second opposing sides and at least one spring, the device comprises a blade contacting portion situated in the cavity of the second side wall and adapted to fit through the aperture and contact a blade during a locked position, and the first spring is extended to secure the blade contacting portion to the blade during the locked position, and the slidable portion is moved in a direction to contract the first spring to thereby separate the blade contacting portion from the blade to thereby release the blade from the blade holding compartment.

### BRIEF DESCRIPTION OF THE DRAWINGS

The accompanying drawings are included to provide a further understanding of the present invention. These drawings are incorporated in and constitute a part of this specification, illustrate one or more embodiments of the present invention and together with the description, serve to explain the principles of the present invention.

FIG. 1 is a perspective view of the blade holding compartment of the present invention;

FIG. 2 is a perspective view of FIG. 1 showing one of the side walls having a cavity with the blade release device;

FIG. 3 is a perspective view of FIG. 1 showing the second side wall having a cavity for the blade;

FIG. 4 is a perspective view of the blade release device in a locked position; and

FIG. 5 is a perspective view of the blade release device wherein the slidable portion is being moved to contract the springs and release the blades.

Among those benefits and improvements that have been disclosed, other objects and advantages of this invention will become apparent from the following description taken in conjunction with the accompanying drawings. The drawings constitute a part of this specification and include exemplary embodiments of the present invention and illustrate various objects and features thereof.

### DETAILED DESCRIPTION OF THE INVENTION

As required, detailed embodiments of the present invention are disclosed herein; however, it is to be understood that the disclosed embodiments are merely exemplary of the invention that may be embodied in various forms. The figures are not necessarily to scale, some features may be exaggerated to show details of particular components. Therefore, specific structural and functional details disclosed herein are not to be interpreted as limiting, but merely as a basis for the claims and as a representative basis for teaching one skilled in the art to variously employ the present invention.

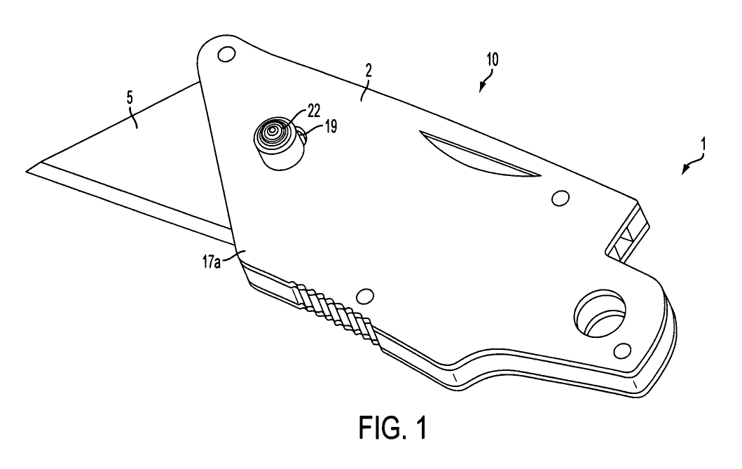

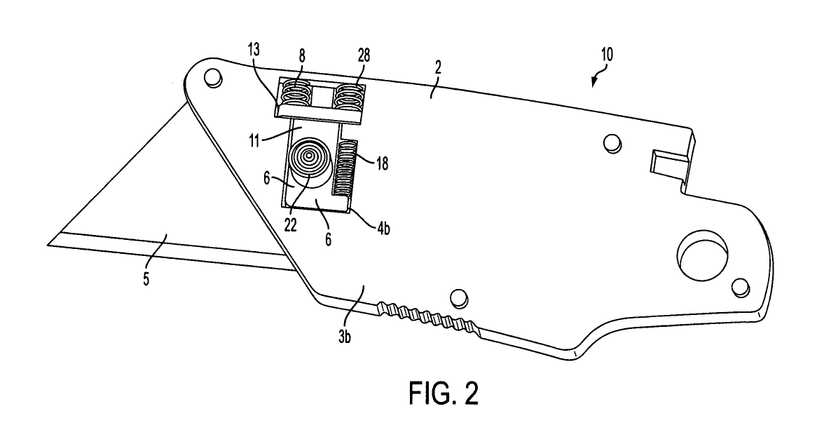

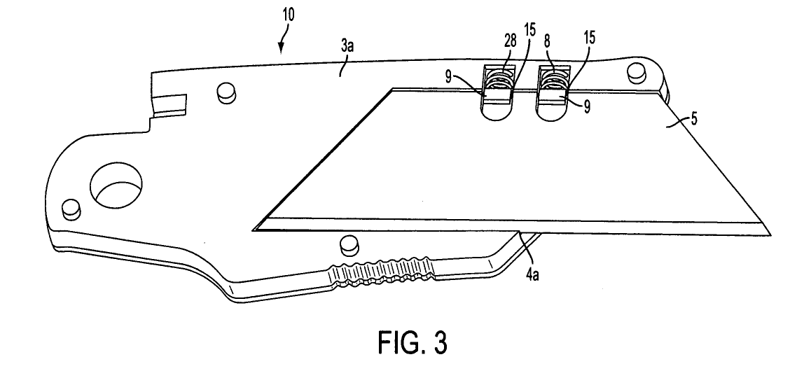

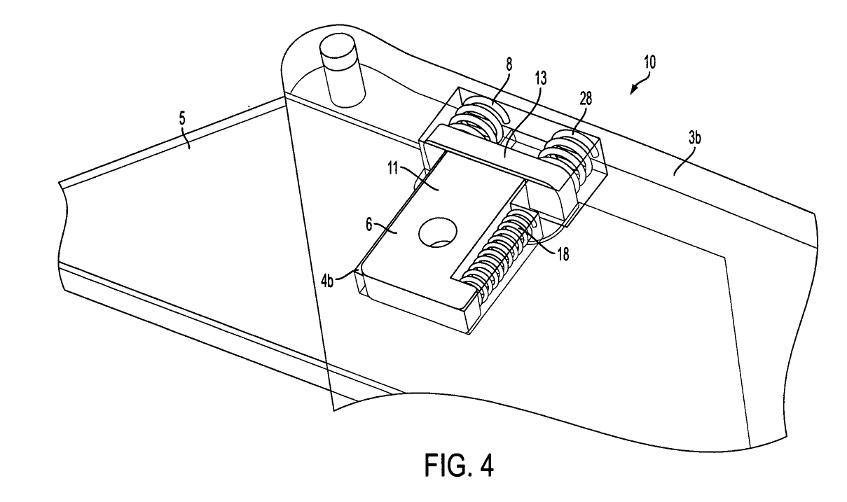

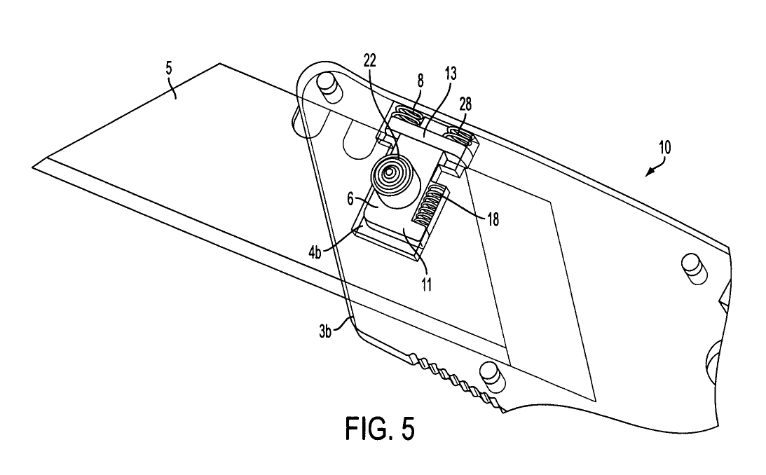

FIGS. 1-5 illustrate the knife 1 and blade release mechanism 10 of the present invention. The knife 1 comprising: a handle (not shown) comprising at least two side walls forming an internal space; a blade holding compartment 2 connected to the handle, the blade holding compartment 2 comprising at least two side walls 3a and b, respectively. The first side wall 3a has a cavity 4a for holding a blade 5, and the second side wall 3b has a cavity 4b for holding a blade release device 11. At least a portion of the blade holding compartment 2 is designed to be situated within the space of the handle during a closed position. The blade holding compartment 2 comprises an aperture 15 leading from the cavity 4a on the first side wall 3a to the cavity 4b on the second side wall 3b. The blade release device 11 comprising a slidable portion 6 having first and second opposing sides, 7a and b respectively, and at least one spring 8. The device 11 comprises a blade contacting portion 9 situated in the cavity 4b of the second side wall 3b and adapted to fit through the aperture 15 and contact a blade 5 during a locked position. The spring 8 is extended to secure the blade contacting portion 9 to the blade 5 during the locked position, and the slidable portion 6 is moved in a direction to contract the spring 8 to thereby separate the blade contacting portion 9 from the blade 5 to thereby release the blade 5 from the blade holding compartment 2.

The device 11 further comprises an actuator 22 situated on the second side 7b of the slidable portion 6, and the actuator 22 is designed to move the slidable portion 6 to release the blade 5.

The device 11 further comprises a second spring 18. The spring 18 is designed to contact the extended portion 13 of the slidable portion 6, and the second spring 18 is extended to assist in securing the blade contacting portion 9 to the blade 5 during the locked position, and the slidable portion 6 is moved in one direction to contract the first and second springs, 8 and 18, to thereby separate the blade contracting portion 9 from the blade 5 and thereby release the blade 5 from the cavity 3a of the blade holding compartment 2.

The slidable portion 6 of the device 11 comprises upper and lower portions, 6a and b respectively. The device further comprises a platform 13 situated on the upper portion 6a of the slidable portion 6. The blade contacting portion 9 is connected to the platform 13. The first spring 8 is situated adjacent to the platform 13. The device 11 further comprises a third spring 28, and the third spring 28 is situated atop the platform 13.

The blade holding compartment 2 further comprises cover plates, 17a and b respectively, for covering the cavities, 4a and b, on side walls, 3a and b, of the blade holding compartment 2. One of the plate covers comprises at least one aperture 19, and the device 11 further comprises an actuator 22 situated on the second side 6b of the slidable portion 6, and the actuator 22 is designed to move the slidable portion 6 to release the blade 5; and at least a portion of the actuator 22 designed to fit through the aperture 19 of the cover plate 17a allowing user access to the actuator 22.

The slidable portion 6 is moved in an upward direction to contract the springs, 8, 18 and 28 and thereby release the blade 5 from the cavity 4b of the blade holding compartment 2.

Numerous modifications and variations of the present invention are possible in light of the above teachings. It is therefore to be understood that within the scope of the attendant claims attached hereto, this invention may be practiced otherwise than as specifically disclosed herein.

What is claimed is:

1. A utility knife with a blade release device, said knife comprising:
a handle comprising at least two side walls forming an internal space;
a blade holding compartment connected to said handle, said blade holding compartment comprising at least two side walls, a first side wall having a cavity for holding a blade, a second side wall having a cavity for holding a blade release device, at least a portion of said blade holding compartment designed to be situated within said space of said handle during a closed position, said blade holding compartment comprising an aperture leading from said cavity on said first side wall to said cavity on said second side wall; and
a blade release device comprising a slidable portion having first and second opposing sides and at least one spring, said device comprises a blade contacting portion situated in said cavity of said second side wall and adapted to fit through said aperture and contact a blade during a locked position, said first spring is extended to secure said blade contacting portion to the blade during said locked position, said slidable portion is moved in a direction to contract said first spring to thereby separate said blade contacting portion from the blade to thereby release the blade from the blade holding compartment.

2. The knife of claim 1 wherein said device further comprises an actuator situated on said second side of said slidable portion, said actuator designed to move said slidable portion to release the blade.

3. The knife of claim 1 further comprising at least one blade.

4. The knife of claim 1 wherein said slidable portion comprises an extended portion.

5. The knife of claim 4 wherein said device further comprises a second spring, said spring designed to contact said extended portion of said slidable portion, said second spring is extended to assist in securing said blade contacting portion to the blade during said locked position, said slidable portion is moved in one direction to contract said first and second springs to thereby separate said blade contracting portion from said blade and thereby release said blade from said internal cavity of said blade holding compartment.

6. The knife of claim 1 wherein said slidable portion of said device comprises upper and lower portions, said device further comprise a platform situated on said upper portion of said slidable portion.

7. The knife of claim 6 wherein said blade contacting portion is connected to said platform.

8. The knife of claim 6 wherein said first spring is situated adjacent to said platform.

9. The knife of claim 6 wherein said device further comprises a third spring, said third spring being situated atop said platform.

10. The knife of claim 1 wherein said blade holding compartment further comprises at least two cover plates for covering said two side walls of said blade holding compartment.

11. The knife of claim 10 wherein at least one of said plate cover comprises at least one aperture, said device further comprises an actuator situated on said second side of said slidable portion, said actuator designed to move said slidable portion to release the blade, at least a portion of said actuator designed to fit through said aperture of said cover plate allowing user access to said actuator.

12. The knife of claim 1 wherein said slidable portion is moved in an upward direction to contract said first spring and thereby release the blade from said internal cavity of said blade holding compartment.

13. A knife of claim 1 wherein said blade holding compartment is pivotally connected to said handle.

14. The knife of claim 1 wherein said blade holding compartment comprises at least one channel and said handles comprises at least one protrusion adapted to slide within said channel to thereby allow said blade holding compartment to be slid within said internal space of said handle during said closed position and to be slid away from said internal space of said handle during an opened position.

15. The knife of claim 1 wherein said blade holding compartment comprises at least one protrusion and said handles comprises at least one channel adapted to slide within said channel to thereby allow said blade holding compartment to be slid within said internal space of said handle during said closed position and to be slid away from said internal space of said handle during an opened position.

16. A blade release system for use with a blade holding compartment, said system comprises:
a blade holding compartment comprising at least two side walls forming an internal blade cavity for holding a blade, said blade holding compartment comprising a cavity situated on an external surface on one of said side walls of said blade holding compartment, said blade holding compartment comprising an aperture leading from said cavity on said external surface of one of said side walls to said internal blade cavity; and
a blade release device comprising a slidable portion having first and second opposing sides and at least one spring, said device comprises a blade contacting portion situated on said first side of said slidable portion and adapted to fit through said aperture and contact a blade during a locked position, said first spring is extended to secure said blade contacting portion to the blade during said locked position, said slidable portion is moved in a direction to contract said first spring to thereby separate said blade contacting portion from the blade to thereby release the blade from the blade holding compartment.

17. The system of claim 16 further comprising at least one blade.

18. The system of claim 17 wherein said blade comprises at least one indentation.

19. The system of claim 17 wherein said blade contacting portion comprises at least one protrusion, said protrusion contacts said indentation of said blade during said locked position and said protrusion disengages said indentation of said blade to thereby release said blade from said internal cavity of said blade holding compartment.

20. A knife with blade release system comprising:
a handle comprising at least two side walls forming an internal space;
a blade holding compartment comprising at least two side walls forming an internal blade cavity for holding a blade, said blade holding compartment comprising an aperture leading from an external surface of one of said side walls to said internal blade cavity, said blade holding compartment being situated within said internal space of said handle during a closed position, said blade holding compartment being situated outside said internal space of said handle during an opened position;
a blade; and
a blade release device comprising a slidable portion having first and second opposing sides and at least one spring, said device comprises a blade contacting portion situated on said first side of said slidable portion and adapted to fit through said aperture and contact a blade during a locked position, said first spring is extended to secure said blade contacting portion to the blade during said locked position, said slidable portion is moved in a direction to contract said first spring to thereby separate said blade contacting portion from said blade to thereby release the blade from said blade holding compartment.
